(19) United States
(12) Patent Application Publication
(10) Pub. No.: US 2026/0149535 A1
(43) Pub. Date: May 28, 2026

(54) FEEDBACK PROCESS IDENTIFIERS WITH RESTRICTED FEEDBACK PROCESS FUNCTIONALITIES

(71) Applicant: QUALCOMM Incorporated, San Diego, CA (US)

(72) Inventors: Morteza SOLTANI, San Diego, CA (US); Mostafa KHOSHNEVISAN, San Diego, CA (US); Jing SUN, San Diego, CA (US); Jae Ho RYU, San Diego, CA (US)

(21) Appl. No.: 18/957,473

(22) Filed: Nov. 22, 2024

(51) Int. Cl. H04L 1/1822; H04L 1/1812

(52) U.S. Cl. CPC H04L 1/1822; H04L 1/1812

(57) ABSTRACT

Methods, systems, and devices for wireless communications are described. A network may configure user equipments (UEs) with different types of hybrid automatic repeat request (HARQ) process identifiers (IDs) associated with varying complexities and UE capabilities. In the context of HARQ-enabled process IDs, UEs may be expected or configured to transmit ACK or NACK messages in response to downlink messages, and to store log likelihood ratios (LLRs) for failed downlink messages. HARQ-restricted process IDs may be associated with “restricted” HARQ process parameters or functionalities that reduce the complexity of the UE (e.g., reduce processing and/or memory requirements). For example, HARQ-restricted process IDs may be associated with a higher LLR compression ratio to reduce the quantity of data that is stored for LLRs of failed downlink messages. In other cases, HARQ-restricted process IDs may be associated with a lower target block error rate, a lower threshold transport block size, or both.

### FIELD OF TECHNOLOGY

The following relates to wireless communications, including feedback process identifiers with restricted feedback process functionalities.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity, control signaling indicating a first set of hybrid automatic repeat request (HARQ) process identifiers (IDs) associated with a set of HARQ-enabled process parameters, and a second set of HARQ process IDs associated with a set of HARQ-restricted process parameters that are restricted relative to the set of HARQ-enabled process parameters, receiving, from the network entity, a downlink message associated with a HARQ process ID from one of the first set of HARQ process IDs or the second set of HARQ process IDs, and transmitting a feedback message in response to the downlink message and in accordance with one of the set of HARQ-enabled process parameters or the set of HARQ-restricted process parameters based on the HARQ process ID associated with the downlink message.

A UE for wireless communications is described. The UE may include one or more memories storing processor executable code, and one or more processors coupled with the one or more memories. The one or more processors may individually or collectively be operable to execute the code to cause the UE to receive, from a network entity, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters, receive, from the network entity, a downlink message associated with a HARQ process ID from one of the first set of HARQ process IDs or the second set of HARQ process IDs, and transmit a feedback message in response to the downlink message and in accordance with one of the set of HARQ-enabled process parameters or the set of HARQ-restricted process parameters based on the HARQ process ID associated with the downlink message.

Another UE for wireless communications is described. The UE may include means for receiving, from a network entity, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters, means for receiving, from the network entity, a downlink message associated with a HARQ process ID from one of the first set of HARQ process IDs or the second set of HARQ process IDs, and means for transmitting a feedback message in response to the downlink message and in accordance with one of the set of HARQ-enabled process parameters or the set of HARQ-restricted process parameters based on the HARQ process ID associated with the downlink message.

A non-transitory computer-readable medium storing code for wireless communications is described. The code may include instructions executable by one or more processors to receive, from a network entity, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters, receive, from the network entity, a downlink message associated with a HARQ process ID from one of the first set of HARQ process IDs or the second set of HARQ process IDs, and transmit a feedback message in response to the downlink message and in accordance with one of the set of HARQ-enabled process parameters or the set of HARQ-restricted process parameters based on the HARQ process ID associated with the downlink message.

In some examples of the method, UEs, and non-transitory computer-readable medium described herein, the set of HARQ-enabled process parameters, the set of HARQ-restricted process parameters, or both, include a log-likelihood ratio (LLR) compression ratio, a target block error rate (BLER), a maximum transport block size (TBS), a downlink message priority, or any combination thereof.

In some examples of the method, UEs, and non-transitory computer-readable medium described herein, the set of HARQ-enabled process parameters include a first log-likelihood compression ratio and the set of HARQ-restricted process parameters include a second log-likelihood compression ratio that may be associated with a higher rate of compression as compared to the first log-likelihood compression ratio.

Some examples of the method, UEs, and non-transitory computer-readable medium described herein may further include operations, features, means, or instructions for storing in memory an LLR associated with the downlink message based on a failure to receive or decode the downlink message, where the LLR may be stored in accordance with the first log-likelihood compression ratio based on the downlink message being associated with the first set of HARQ process IDs, or in accordance with the second log-likelihood compression ratio based on the downlink message being associated with the second set of HARQ process IDs.

In some examples of the method, UEs, and non-transitory computer-readable medium described herein, the set of HARQ-enabled process parameters include a first maximum TBS and the set of HARQ-restricted process parameters include a second maximum TBS.

In some examples of the method, UEs, and non-transitory computer-readable medium described herein, the downlink message may be associated with a TBS, the TBS may be based on the first maximum TBS based on the downlink message being associated with the first set of HARQ process IDs, and the TBS may be based on the second maximum TBS based on the downlink message being associated with the second set of HARQ process IDs.

In some examples of the method, UEs, and non-transitory computer-readable medium described herein, the set of HARQ-enabled process parameters include a first target BLER and the set of HARQ-restricted process parameters include a second target BLER that may be less than the first target BLER.

Some examples of the method, UEs, and non-transitory computer-readable medium described herein may further include operations, features, means, or instructions for identifying a failure to successfully receive or decode the downlink message, where the failure may be identified in accordance with the first target BLER based on the downlink message being associated with the first set of HARQ process IDs, or in accordance with the second target BLER based on the downlink message being associated with the second set of HARQ process IDs and storing in memory an LLR associated with the downlink message based on the failure.

In some examples of the method, UEs, and non-transitory computer-readable medium described herein, the first set of HARQ process IDs and the second set of HARQ process IDs may be based at least in a part on one or more capabilities of the UE.

Some examples of the method, UEs, and non-transitory computer-readable medium described herein may further include operations, features, means, or instructions for transmitting, to the network entity, capability signaling indicating the one or more capabilities of the UE, where the control signaling may be received based on the capability signaling.

In some examples of the method, UEs, and non-transitory computer-readable medium described herein, the one or more capabilities of the UE include a maximum quantity of total HARQ process IDs supported at the UE per component carrier, a maximum quantity of HARQ-enabled process IDs supported at the UE per component carrier, a maximum quantity of HARQ-restricted process IDs supported at the UE per component carrier, a processing or memory capability of the UE, or any combination thereof.

In some examples of the method, UEs, and non-transitory computer-readable medium described herein, the control signaling includes radio resource control signaling, medium access control-control element signaling, downlink control information signaling, or any combination thereof.

In some examples of the method, UEs, and non-transitory computer-readable medium described herein, the downlink message may be associated with the first set of HARQ process IDs and the method, apparatuses, and non-transitory computer-readable medium may include further operations, features, means, or instructions for transmitting, via the feedback message, an indication that the downlink message was processed in accordance with the set of HARQ-restricted process parameters based on one or more capabilities of the UE being exceeded.

A method for wireless communications by a network entity is described. The method may include outputting, to a UE, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters, outputting, to the UE, a downlink message associated with a HARQ process ID from one of the first set of HARQ process IDs or the second set of HARQ process IDs, and obtaining a feedback message in response to the downlink message and in accordance with one of the set of HARQ-enabled process parameters or the set of HARQ-restricted process parameters based on the HARQ process ID associated with the downlink message.

A network entity for wireless communications is described. The network entity may include one or more memories storing processor executable code, and one or more processors coupled with the one or more memories. The one or more processors may individually or collectively be operable to execute the code to cause the network entity to output, to a UE, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters, output, to the UE, a downlink message associated with a HARQ process ID from one of the first set of HARQ process IDs or the second set of HARQ process IDs, and obtain a feedback message in response to the downlink message and in accordance with one of the set of HARQ-enabled process parameters or the set of HARQ-restricted process parameters based on the HARQ process ID associated with the downlink message.

Another network entity for wireless communications is described. The network entity may include means for outputting, to a UE, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters, means for outputting, to the UE, a downlink message associated with a HARQ process ID from one of the first set of HARQ process IDs or the second set of HARQ process IDs, and means for obtaining a feedback message in response to the downlink message and in accordance with one of the set of HARQ-enabled process parameters or the set of HARQ-restricted process parameters based on the HARQ process ID associated with the downlink message.

A non-transitory computer-readable medium storing code for wireless communications is described. The code may include instructions executable by one or more processors to output, to a UE, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters, output, to the UE, a downlink message associated with a HARQ process ID from one of the first set of HARQ process IDs or the second set of HARQ process IDs, and obtain a feedback message in response to the downlink message and in accordance with one of the set of HARQ-enabled process parameters or the set of HARQ-restricted process parameters based on the HARQ process ID associated with the downlink message.

In some examples of the method, network entities, and non-transitory computer-readable medium described herein, the set of HARQ-enabled process parameters, the set of HARQ-restricted process parameters, or both, include an LLR compression ratio, a target BLER, a maximum TBS, a downlink message priority, or any combination thereof.

In some examples of the method, network entities, and non-transitory computer-readable medium described herein, the set of HARQ-enabled process parameters include a first log-likelihood compression ratio and the set of HARQ-restricted process parameters include a second log-likelihood compression ratio that may be associated with a higher rate of compression as compared to the first log-likelihood compression ratio.

In some examples of the method, network entities, and non-transitory computer-readable medium described herein, the set of HARQ-enabled process parameters include a first maximum TBS and the set of HARQ-restricted process parameters include a second maximum TBS.

In some examples of the method, network entities, and non-transitory computer-readable medium described herein, the downlink message may be transmitted associated with a TBS, the TBS may be based on the first maximum TBS based on the downlink message being associated with the first set of HARQ process IDs, and the TBS may be based on the second maximum TBS based on the downlink message being associated with the second set of HARQ process IDs.

In some examples of the method, network entities, and non-transitory computer-readable medium described herein, the set of HARQ-enabled process parameters include a first target BLER and the set of HARQ-restricted process parameters include a second target BLER that may be less than the first target BLER.

In some examples of the method, network entities, and non-transitory computer-readable medium described herein, the first set of HARQ process IDs and the second set of HARQ process IDs may be based at least in a part on one or more capabilities of the UE.

Some examples of the method, network entities, and non-transitory computer-readable medium described herein may further include operations, features, means, or instructions for obtaining, from the UE, capability signaling indicating the one or more capabilities of the UE, where the control signaling may be transmitted based on the capability signaling.

In some examples of the method, network entities, and non-transitory computer-readable medium described herein, the one or more capabilities of the UE include a maximum quantity of total HARQ process IDs supported at the UE per component carrier, a maximum quantity of HARQ-enabled process IDs supported at the UE per component carrier, a maximum quantity of HARQ-restricted process IDs supported at the UE per component carrier, a processing or memory capability of the UE, or any combination thereof.

In some examples of the method, network entities, and non-transitory computer-readable medium described herein, the control signaling includes radio resource control signaling, medium access control-control element signaling, downlink control information signaling, or any combination thereof.

In some examples of the method, network entities, and non-transitory computer-readable medium described herein, the downlink message may be associated with the first set of HARQ process IDs and the method, apparatuses, and non-transitory computer-readable medium may include further operations, features, means, or instructions for obtaining, via the feedback message, an indication that the downlink message was processed in accordance with the set of HARQ-restricted process parameters based on one or more capabilities of the UE being exceeded.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports feedback process identifiers (IDs) with restricted feedback process functionalities in accordance with one or more aspects of the present disclosure.

FIG. 2 shows an example of a wireless communications system that supports feedback process IDs with restricted feedback process functionalities in accordance with one or more aspects of the present disclosure.

FIG. 3 shows an example of a process flow that supports feedback process IDs with restricted feedback process functionalities in accordance with one or more aspects of the present disclosure.

FIGS. 4 and 5 show block diagrams of devices that support feedback process IDs with restricted feedback process functionalities in accordance with one or more aspects of the present disclosure.

FIG. 6 shows a block diagram of a communications manager that supports feedback process IDs with restricted feedback process functionalities in accordance with one or more aspects of the present disclosure.

FIG. 7 shows a diagram of a system including a device that supports feedback process IDs with restricted feedback process functionalities in accordance with one or more aspects of the present disclosure.

FIGS. 8 and 9 show block diagrams of devices that support feedback process IDs with restricted feedback process functionalities in accordance with one or more aspects of the present disclosure.

FIG. 10 shows a block diagram of a communications manager that supports feedback process IDs with restricted feedback process functionalities in accordance with one or more aspects of the present disclosure.

FIG. 11 shows a diagram of a system including a device that supports feedback process IDs with restricted feedback process functionalities in accordance with one or more aspects of the present disclosure.

FIGS. 12 and 13 show flowcharts illustrating methods that support feedback process IDs with restricted feedback process functionalities in accordance with one or more aspects of the present disclosure.

### DETAILED DESCRIPTION

Some wireless communications systems may use hybrid automatic repeat request (HARQ) processes to improve a reliability of wireless communications. In some cases, a single cell or component carrier may be configured with up to 16 HARQ process identifiers (IDs). In accordance with a HARQ process, a UE may receive a downlink message associated with a HARQ process ID, process/decode the downlink message, and transmit a feedback message (e.g., acknowledgment (ACK) or negative-acknowledgment (NACK)) indicating whether or not the downlink message for the respective HARQ process ID was successfully received and/or processed. If the downlink message was not successfully received or processed, the UE may store a log-likelihood ratio (LLR) value associated with the failed downlink message in memory, and transmit a NACK message to trigger the network to retransmit the failed downlink message. Upon receiving the retransmission, the UE may combine a new LLR for the retransmission and the stored LLR of the original transmission in order to improve a probability that the retransmission will be successfully decoded. However, storing such LLRs increases processing and memory requirements at the UE. Further, in some cases, a UE may use a single uplink slot/message to provide HARQ feedback for multiple (e.g., 16 or more) downlink messages associated with different HARQ process IDs. This results in increased UE complexity, particularly if many of the downlink messages are not successfully received and the UE is expected to store LLRs for the failed downlink messages.

Techniques described herein may support configuring separate sets of HARQ process IDs, including HARQ-enabled process IDs and HARQ-restricted process IDs. That is, aspects described herein may enable the network to configure UEs with different types of HARQ process IDs associated with varying complexities and UE capabilities. As with previous HARQ processes, in the context of HARQ-enabled process IDs, UEs may be expected or configured to transmit ACK or NACK messages in response to downlink messages, and to store LLRs for failed downlink messages. Comparatively, HARQ-restricted process IDs may be associated with “restricted” HARQ process parameters or functionalities that reduce the complexity of the UE (e.g., reduce processing and/or memory requirements). For example, HARQ-restricted process IDs may be associated with a higher LLR compression ratio to reduce the quantity of data that is stored for LLRs of failed downlink messages. In other cases, HARQ-restricted process IDs may be associated with a lower target block error rate (BLER), a lower threshold (e.g., maximum) transport block size (TBS), or both, thereby reducing the complexity of the feedback process for downlink messages associated with HARQ-restricted process IDs.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to feedback process IDs with restricted feedback process functionalities.

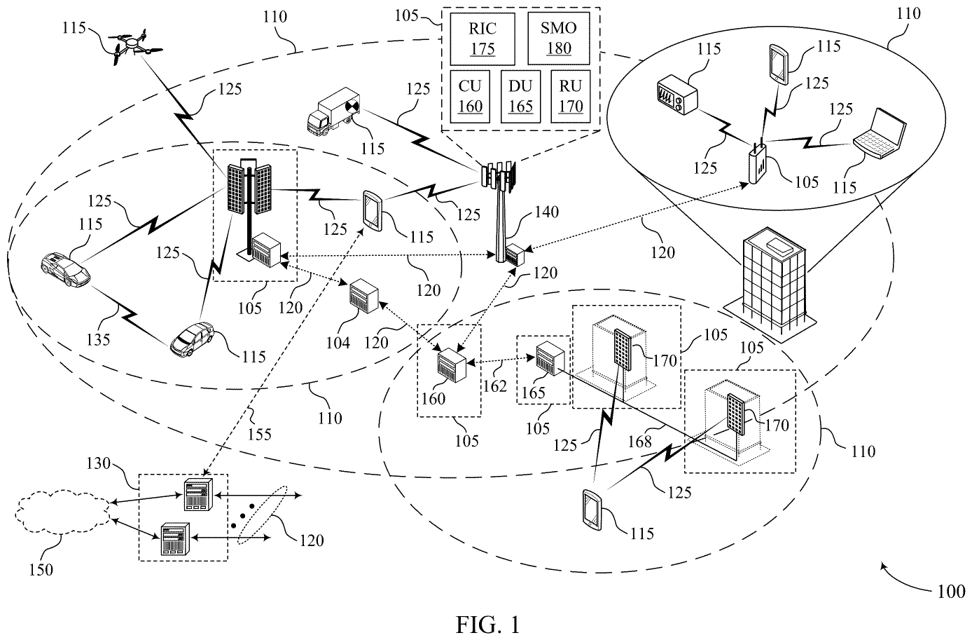

FIG. 1 shows an example of a wireless communications system 100 that supports feedback process IDs with restricted feedback process functionalities in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support feedback process IDs with restricted feedback process functionalities as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation (CA) or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, devices may support asynchronous HARQ feedback for downlink and uplink signaling to avoid a fixed timing relationship between an initial transmission and a re-transmission. In some cases, a UE may support transmitting HARQ feedback (e.g., ACK or NACK feedback) for multiple downlink transmissions (in time) in one uplink data region or control region. Some wireless communications systems may support a limited quantity (e.g., a maximum quantity) of HARQ processes per carrier (e.g., 16 HARQ processes for each carrier). A threshold quantity (e.g., a maximum number) of HARQ processes for unicast physical downlink shared channel (PDSCH) transmissions may be RRC configured per cell for a UE 115. For example, the UE 115 may receive RRC signaling that includes a configuration with the threshold quantity of HARQ processes for unicast PDSCH on a per-cell basis. In some examples, each retransmission of a set of retransmissions may occupy a different frequency allocation than an initial transmission. In some cases, for downlink transmission, transmission durations for a transport block may not be the same (e.g., durations of each retransmission of the transport block may be different). Similarly, for uplink transmission, transmission durations for a transport block may not be the same (e.g., at least for uplink transmissions scheduled by an uplink grant). In some examples, a UE may use a reserved modulation and coding scheme (MCS) for cases where a re-transmission uses a different quantity of resources than an original transmission.

Some wireless communications systems may support HARQ-disabled downlink transmission for devices using frequency range 1(FR1), frequency range 2 (FR2), or both. Implementing such HARQ-disabled downlink transmission may avoid a reduction of peak downlink FR2 throughput with CA (e.g., FR1+FR2 carrier aggregation) scheduled with a single physical uplink control channel (PUCCH) group on FR1. In some wireless communications systems, a network entity 105 may configure a threshold quantity of HARQ processes (e.g., more than 16) for HARQ-disabled downlink transmissions, where two sets of HARQ process IDs may be defined.

For example, a first set of HARQ process IDs may include HARQ-enabled process IDs (e.g., NR baseline HARQ process IDs). For HARQ-enabled downlink transmissions, a UE may be expected to perform HARQ combining for PDSCH (e.g., storing LLRs associated with the HARQ-enabled process IDs) and to provide HARQ-ACK or HARQ-NACK feedback to indicate success or failure of a PDSCH decoding procedure. A second set of HARQ process IDs may include HARQ-disabled process IDs. For associated downlink transmissions the UE 115 may not be expected to store LLRs (e.g., the UE 115 may refrain from performing HARQ combining) for a failed PDSCH reception. However, the UE 115 may still provide HARQ feedback to indicate whether a PDSCH decoding procedure has failed. In some cases, for HARQ-disabled process IDs, the UE 115 may discard (e.g., refrain from storing) LLRs for failed PDSCH receptions.

Some wireless communications systems may support a CA (e.g., an FR1+FR2 carrier aggregation) coverage extension with a single PUCCH group. That is, a wireless communications system may support a single PUCCH group to extend the coverage for FR2 downlink coverage extension associated with the CA. In a first example, a UE 115 may receive downlink communication (e.g., via PDSCH) on FR2, while the UE may communicate via a PUCCH group that is on FR1. The downlink communication (e.g., the PDSCH transmission) may include a relatively high quantity of downlink slots, corresponding to a relatively high quantity of HARQ IDs (e.g., HARQ process IDs). The PUCCH group may include only one uplink slot to provide HARQ feedback for the relatively high quantity of downlink slots. That is, because each downlink slot may be associated with a HARQ ID, the UE 115 may use a single PUCCH group to provide HARQ feedback for the relatively high quantity of HARQ IDs. For example, the PUCCH group may only support HARQ feedback for 16 HARQ IDs, but the relatively high quantity of HARQ IDs may include 29 HARQ IDs (e.g., since 29 is greater than 16, the PUCCH group may be insufficient for such a procedure). This may result in increased UE complexity if all HARQ IDs are configured with HARQ-enabled process functionalities (e.g., as defined in one or more 5G NR specifications).

Thus, to reduce UE complexity, techniques described herein may support some HARQ IDs being configured with restricted HARQ process functionality. The wireless communications system 100 may support configuring separate sets of HARQ process IDs, including HARQ-enabled process IDs and HARQ-restricted process IDs. For example, a network entity 105 of the wireless communications system 100 may configure UEs 115 with different types of HARQ process IDs associated with varying complexities and UE capabilities. As with previous HARQ processes, in the context of HARQ-enabled process IDs, UEs 115 may be expected or configured to transmit ACK or NACK messages in response to downlink messages, and to store LLRs for failed downlink messages. Comparatively, HARQ-restricted process IDs may be associated with “restricted” HARQ process parameters or functionalities that reduce the complexity of the UE 115 (e.g., reduce processing and/or memory requirements). For example, HARQ-restricted process IDs may be associated with a higher LLR compression ratio to reduce the quantity of data that is stored for LLRs of failed downlink messages. Additionally, or alternatively, HARQ-restricted process IDs may be associated with a lower target BLER, a lower threshold (e.g., maximum) TBS, or both, thereby reducing the complexity of the feedback process for downlink messages associated with HARQ-restricted process IDs.

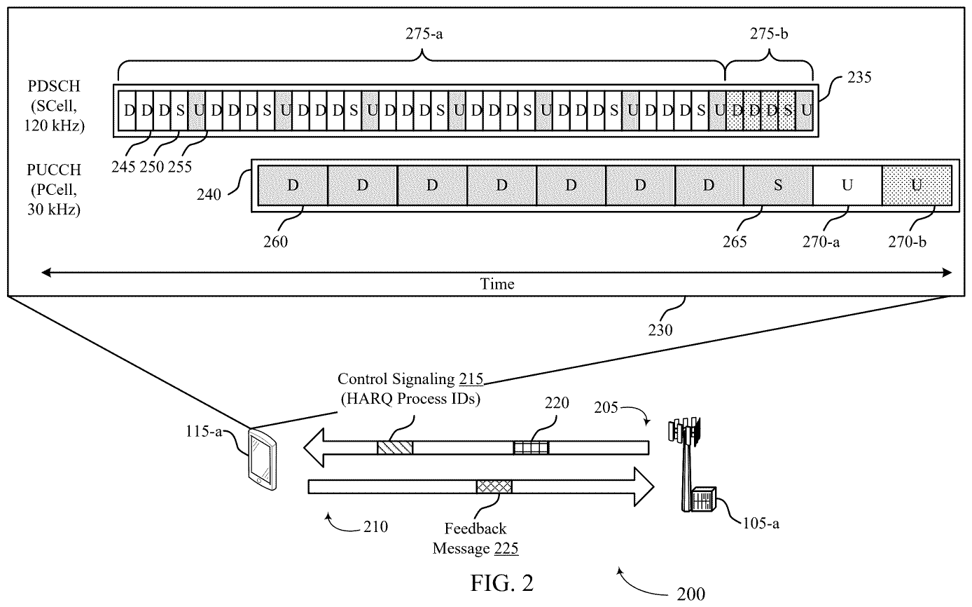

FIG. 2 shows an example of a wireless communications system 200 that supports feedback process IDs with restricted feedback process functionalities in accordance with one or more aspects of the present disclosure. In some cases, the wireless communications system 200 may implement, or be implemented by, aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein. The UE 115-a may transmit one or more uplink messages to the network entity 105-a via a wireless communication link 205. Similarly, the UE 115-a may receive one or more downlink messages from the network entity 105-a via a wireless communication link 210 (which may in some cases be a same wireless communication link as the wireless communication link 205).

In some implementations, the UE 115-a may receive, via the wireless communication link 205, control signaling 215 from the network entity 105-a. The control signaling 215 may indicate one or more HARQ process IDs associated with HARQ-enabled process parameters (which may be referred to herein as HARQ-enabled process IDs, HARQ-enabled IDs, or enabled IDs) and one or more HARQ process IDs associated with HARQ-restricted process parameters (which may be referred to herein as HARQ-restricted process IDs, HARQ-restricted IDs, or restricted IDs).

In some implementations, the UE 115-a may receive, via the wireless communication link 205, a downlink message 220 from the network entity 105-a. The downlink message 220 may be associated with a HARQ-enabled process ID or a HARQ-restricted process ID. In other words, the downlink message may indicate (via an indicated HARQ process ID) which HARQ process the UE 115-a is expected to use to provide feedback for the downlink message 220 (and/or other communications scheduled by the downlink message 220).

In some cases, the UE 115-a may determine whether reception (and decoding) of the downlink message 220 is successful. For example, if the UE 115-a detects that the downlink message 220 includes one or more errors above an error threshold (e.g., a BLER threshold), the UE 115-a may determine that reception of the downlink message 220 (or decoding thereof) was unsuccessful. Accordingly, the UE 115-a may determine to transmit a HARQ-NACK indication associated with the downlink message 220 to request retransmission of the downlink message 220. In response to determining that the reception was unsuccessful, the UE 115-a may store one or more LLRs associated with the downlink message 220 in one or more memories of the UE 115-a. The UE 115-a may store the one or more LLRs in accordance with the HARQ ID associated with the downlink message 220.

For example, the UE 115-a may store the one or more LLRs according to a scheme (e.g., a compression scheme) that is based on a type of the HARQ ID (e.g., whether the HARQ ID is a HARQ-enabled ID or a HARQ-restricted ID as described herein). For instance, in accordance with a HARQ-enabled process ID, the UE 115-a may be configured to store multiple bits of information associated with the LLR. Comparatively, in accordance with a HARQ-restricted process ID, the UE 115-a may be configured to store fewer quantities of bits associated with the LLR, such as by storing only the most significant bit (MSB) of the LLR. In some implementations, the UE 115-a may use the one or more LLRs to receive and decode a retransmission of the downlink message 220.

In response to the downlink message 220, the UE 115-a may transmit, via the wireless communication link 210, a feedback message 225 to the network entity 105-a. The feedback message 225 may be transmitted according to one or more parameters based on the HARQ process ID associated with the downlink message 220. For example, if the downlink message 220 is associated with a HARQ-enabled process ID, the UE 115-a may transmit the feedback message 225 according to a set of corresponding HARQ-enabled parameters. Similarly, if the downlink message 220 is associated with a HARQ-restricted process ID, the UE 115-a may transmit the feedback message 225 according to a set of corresponding HARQ-restricted parameters.

To receive the downlink message 220 and to transmit the feedback message 225, the UE 115-a may communicate as illustrated by timing diagram 230. For example, the UE 115-a may communicate using PDSCH slots 235 and PUCCH groups 240. The PDSCH slots 235 may include downlink slots 245, special slots 250, and uplink slots 255. The PUCCH groups 240 may include downlink groups 260, special groups 265, and uplink groups 270 (e.g., an uplink group 270-a and an uplink group 270-b). As illustrated, a horizontal axis within the timing diagram 230 may represent time.

In some cases, the UE 115-a may communicate via a PUCCH according to a first frequency range (e.g., FR1, or a lower frequency range) and may communicate via a PDSCH according to a second frequency range (e.g., FR2, or a higher frequency range). For instance, as shown in FIG. 2, the UE 115-a may transmit uplink communications via a PUCCH component carrier or cell (e.g., PCell), and may receive downlink communications via a PDSCH component carrier or cell (e.g., SCell). In this example, the PUCCH cell may be associated with a 30 kHz SCS, and the PDSCH cell may be associated with 120 kHz SCS. Accordingly, due to the difference in SCSs, each PDSCH slot 235 may span a shorter duration than a PUCCH group 240. The uplink group 270-a (e.g., a single PUCCH group) may include feedback information (e.g., ACK or NACK) associated with any downlink slots 245, special slots 250, or a combination thereof, within a first interval 275-a. Similarly, the uplink group 270-b may include feedback information associated with any downlink slots 245, special slots 250, or a combination thereof, within a second interval 275-b. As described herein, a downlink message 220 may refer to or may include one or more slots that carry downlink signaling (e.g., downlink slots 245, special slots 250 carrying downlink signaling, or the like). Similarly, a feedback message 225 may refer to or may include an uplink group 270 (e.g., the uplink group 270-a or the uplink group 270-b).

In some implementations, a downlink serving cell (e.g., associated with the network entity 105-a) may restrict a functionality of some HARQ-IDs. That is, some HARQ-IDs may be configured with restricted HARQ functionalities. These HARQ-IDs may be referred to herein as HARQ-restricted process IDs. Such HARQ-restricted process IDs may be different than HARQ-disabled process IDs. For example, HARQ-disabled process IDs may indicate that the UE 115-a is not to store one or more LLRs for an associated downlink message 220. Comparatively, HARQ-restricted process IDs may provide feedback functionality which is restricted compared to HARQ-enabled process IDs, but which is more robust as compared to completely HARQ-disabled process IDs. That is, HARQ-restricted process IDs may provide a sort of “middle ground” between fully-enabled and fully-disabled HARQ process IDs.

In some cases, the downlink serving cell may be configured with a combination (e.g., a mix) of HARQ-enabled HARQ processes and HARQ-restricted HARQ processes. For example, the downlink serving cell may be configured with 32 HARQ processes, where a first set of HARQ IDs (e.g., HARQ IDs 0-5) are HARQ-enabled IDs and a second set of HARQ IDs (e.g., HARQ IDs 16-1) are HARQ-restricted IDs. The second set of HARQ IDs may be restricted with respect to an LLR compression ratio (e.g., LLRs are not compressed for HARQ IDs 0-5, but LLRs corresponding to HARQ IDs 16-1 are compressed). In such cases, the first set may be associated with a first (e.g., “normal”) HARQ-enabled downlink transmission while the second set may be associated with a second (e.g., restricted) HARQ process downlink transmission. In some cases, the UE 115-a may be expected to store LLRs corresponding to the first set of HARQ IDs without any compression. Additionally, or alternatively, the UE 115-a may be expected to compress, and then store, LLRs corresponding to the second set of HARQ IDs.

In some implementations, the downlink serving cell (e.g., via the network entity 105-a) may indicate one or more HARQ-restricted process IDs semi-statically (e.g., via an RRC message) or dynamically (e.g., via a MAC-control element (MAC-CE) or via downlink control information (DCI)). For example, the control signaling 215 may include a MAC-CE message, a DCI message, or both.

In some cases, the UE 115-a may transmit capability information (indicating a UE capability of the UE 115-a) to the network entity 105-a (e.g., the downlink serving cell). In such cases, the downlink serving cell may indicate a configuration of HARQ-restricted IDs based on the capability information. The configuration may include a combination (e.g., a mix) of HARQ-enabled and HARQ-restricted process IDs (e.g., based on the capability information). The capability information (corresponding to one or more capabilities of the UE 115-a) may include one or more indications of threshold HARQ processes (e.g., a threshold for each type of HARQ process) supported by the UE. For example, the one or more indications may include a threshold (e.g., a maximum) quantity of total HARQ processes per component carrier, a threshold (e.g., a maximum) quantity of HARQ-enabled HARQ processes per component carrier, a threshold (e.g., a maximum) quantity of HARQ-restricted HARQ processes per component carrier, or any combination thereof. Additionally, or alternatively, the capability information (e.g., UE capability signaling) may include parameters corresponding to one or more particular restricted functionalities (e.g., restricted functionalities further described herein).

In some implementations, the UE 115-a may perform one or more HARQ-restricted feedback processes (e.g., using HARQ-restricted process IDs) according to one or more restriction schemes. Although presented as separate restriction schemes, the UE 115-a may perform feedback procedures according to aspects of a combination of the one or more restriction schemes described herein.

In accordance with a first restriction scheme (e.g., in a first option), the restriction on HARQ process functionalities may be in terms of a target BLER. For example, a first set of HARQ IDs (e.g., HARQ-enabled IDs as described herein) may be based on a first threshold BLER (e.g., a 5G NR baseline such as 10% BLER). That is, if the UE 115-a receives a downlink message 220 that has a BLER below the first threshold BLER (e.g., a first target BLER), and if the downlink message 220 is associated with a HARQ-restricted process ID, the UE 115-a may store LLRs associated with the downlink message 220. A second set of HARQ IDs (e.g., HARQ-restricted IDs) may be scheduled with a relatively more conservative BLER (e.g., a second threshold BLER) for an initial transmission (e.g., 1% BLER or less). That is, if the UE 115-a receives a downlink message 220 that has a BLER below the second threshold BLER (e.g., a lower threshold BLER), and if the downlink message 220 is associated with a HARQ-restricted process ID, the UE 115-a may store LLRs associated with the downlink message 220. Since the second threshold BLER is lower than the first threshold BLER, the UE 115-a may store LLRs associated with the second set of HARQ IDs less frequently than LLRs associated with the first set of HARQ IDs (e.g., in accordance with a mechanism associated with HARQ-restricted process IDs).

In some implementations, the UE 115-a may determine one or more HARQ-IDs to be HARQ-restricted IDs based on one or more factors. For example, if a processor usage associated with a feedback procedure (e.g., a double data rate (DDR) usage) exceeds a capability of the UE 115-a (e.g., exceeding a DDR that can be handled by the UE 115-a), the UE 115-a may dynamically indicate that one or more HARQ IDs are HARQ-restricted. In some cases, the UE 115-a may transmit an uplink control information (UCI) message (e.g., as part of a HARQ-ACK) that indicates that LLRs were not saved for a downlink message 220 associated with a NACK (e.g., if the downlink message 220 is associated with a HARQ-restricted ID). Accordingly, the UE 115-a may be expected to determine (e.g., decide) which HARQ IDs may be HARQ-enabled or HARQ-restricted (e.g., at any particular instance of scheduling). In some examples, the UE 115-a may indicate that HARQ IDs are HARQ-restricted IDs for the second set of HARQ IDs (and not for the first set).

In accordance with a second restriction scheme (e.g., in a second option), HARQ-enabled IDs and HARQ-restricted IDs may have different LLR compression ratios. For example, LLRs associated with HARQ-restricted IDs may be more compressed compared to LLRs associated with HARQ-enabled IDs. In some cases, the network entity 105-a and the UE 115-a may perform one or more operations to synchronize information indicating which HARQ IDs are HARQ-enabled IDs (e.g., in the first set) and which HARQ IDs are HARQ-restricted IDs (e.g., in the second set). Thus, the UE 115-a and the network entity 105-a may determine which HARQ IDs are HARQ-restricted IDs, thus determining which HARQ IDs are to have more compressed LLRs (e.g., to ensure correct UE behavior and correct network scheduling).

In some implementations, the UE 115-a may receive one or more configurations that indicate one or more LLR compression ratios for each set of HARQ IDs (e.g., the first set and the second set. For example, the UE 115-a may receive the one or more configuration from the network entity 105-a semi-statically (e.g., via RRC) or dynamically (e.g., via MAC-CE or via DCI). The one or more configurations may be based on the capability information (e.g., corresponding to one or more capabilities of the UE 115-a). For example, the capability information may include a capability of the UE 115-a to perform HARQ-restricted processes using one or more compression ratios for LLRs. The capability information may also indicate one or more compression ratios of LLRs corresponding to HARQ-enabled IDs (e.g., the first set) and HARQ-restricted IDs (e.g., the second set). Additionally, or alternatively, the UE 115-a may transmit an indication of whether the LLRs are compressed with a first ratio (e.g., according to a HARQ-enabled compression or operation) or with a second ratio (e.g., with an additional compression according to a HARQ-restricted compression). The UE 115-a may transmit the indication via one or more bits (e.g., via a single bit) in a UCI message (e.g., the feedback message 225) as part of a HARQ-ACK indication.

In accordance with a third restriction scheme (e.g., in a third option), HARQ-enabled IDs and HARQ-restricted IDs may be associated with different threshold TBSs. In some examples, a PDSCH transmission (e.g., downlink messages 220) scheduled with HARQ-restricted IDs (e.g., in the second set) may have a smaller TBS compared to a PDSCH transmissions scheduled with HARQ-enabled IDs (e.g., in the first set). Accordingly, the network entity 105-a may schedule smaller transport blocks for HARQ-restricted IDs. Additionally, or alternatively, the UE 115-a may indicate a threshold (e.g., a maximum) TBS which is specific to (e.g., associated with) the second set of HARQ IDs (e.g., via UE capability signaling). The network entity 105-a may schedule the smaller transport blocks for the HARQ-restricted IDs according to the threshold TBS.

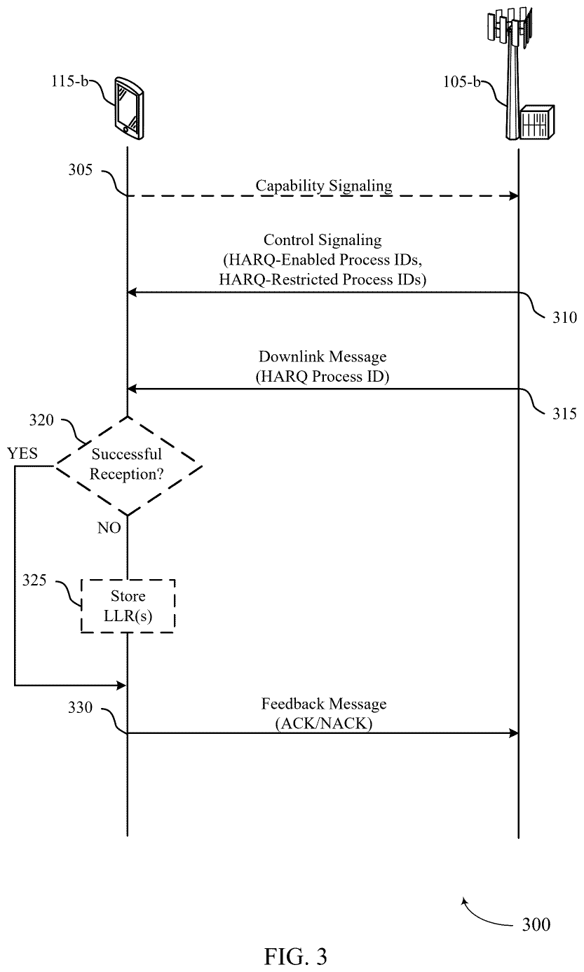

FIG. 3 shows an example of a process flow 300 that supports feedback process IDs with restricted feedback process functionalities in accordance with one or more aspects of the present disclosure. The process flow 300 includes a UE 115-b and a network entity 105-b, which may be examples of the corresponding devices as described with respect to FIGS. 1 and 2. In the following description of the process flow 300, the operations between the UE 115-b and the network entity 105-b may be performed in a different order than the example order shown. Some operations may also be omitted from the process flow 300, and other operations may be added to the process flow 300. Further, although some operations or signaling may be shown to occur at different times for discussion purposes, these operations may actually occur at the same time.

At 305, the UE 115-b may transmit capability signaling to the network entity 105-b. The capability signaling may indicate one or more capabilities of the UE 115-b. That is, the capability signaling may indicate a capability of the UE 115-b to perform HARQ procedures according to HARQ-enabled process IDs, HARQ-restricted process IDs, or both. For example, the capability signaling may indicate a capability of the UE 115-b to store LLRs according to one or more compression schemes (e.g., HARQ-restricted compression schemes). In some cases, the one or more capabilities of the UE 115-b may include a threshold (e.g., a maximum) quantity of total HARQ process IDs supported at the UE 115-b per component carrier, a threshold (e.g., a maximum) quantity of HARQ-enabled process IDs supported at the UE 115-b per component carrier, a threshold (e.g., a maximum) quantity of HARQ-restricted process IDs supported at the UE 115-b per component carrier, a processing or memory capability of the UE 115-b, or any combination thereof.

At 310, the UE 115-b may receive control signaling from the network entity 105-b. The control signaling may indicate a first set of HARQ process IDs associated with a set of HARQ-enabled process parameters and a second set of HARQ process IDs associated with a set of HARQ-restricted process parameters that are restricted relative to the set of HARQ-enabled process parameters. In some cases, the UE 115-b may receive the control signaling based on the capability signaling. In some examples, the first set of HARQ process IDs and the second set of HARQ process IDs may be based on the one or more capabilities of the UE 115-b. In some implementations, the control signaling may include RRC signaling, MAC-CE signaling, DCI signaling, or any combination thereof.

The set of HARQ-enabled process parameters, the set of HARQ-restricted process parameters, or both, may include an LLR compression ratio, a target BLER, a threshold (e.g., a maximum) TBS, a downlink message priority, or any combination thereof. Additionally, or alternatively, the set of HARQ-enabled process parameters may include a first log-likelihood compression ratio and the set of HARQ-restricted process parameters may include a second log-likelihood compression ratio that is associated with a higher rate of compression as compared to the first log-likelihood compression ratio.

At 315, the UE 115-b may receive a downlink message from the network entity 105-b. The downlink message may be associated with a HARQ process ID from one of the first set of HARQ process IDs or the second set of HARQ process IDs. That is, the downlink message may indicate which HARQ process ID is to be used to provide feedback for the downlink message (and/or for communications scheduled by the downlink message). In some implementations, the set of HARQ-enabled process parameters may include a first threshold (e.g., a first maximum) TBS and the set of HARQ-restricted process parameters may include a second threshold (e.g., a second maximum) TBS. In some cases, the TBS may be based on the first threshold TBS if the downlink message is associated with the first set of HARQ process IDs. Additionally, or alternatively, the TBS may be based on the second threshold TBS if the downlink message is associated with the second set of HARQ process IDs. In some implementations, the set of HARQ-enabled process parameters may include a first target BLER. The set of HARQ-restricted process parameters may include a second target BLER that is less than the first target BLER.

At 320, The UE 115-b may determine whether or not the downlink message was successfully received and/or decoded. If the downlink message was successfully received/decoded (e.g., step 320=YES), the process flow 300 may proceed to step 330, where the UE 115-b may transmit a feedback message (e.g., ACK) responsive to the downlink message.

Comparatively, if the downlink message was not successfully received and/or decoded (e.g., step 320=NO), the process flow 300 may proceed to step 325. In some cases, the UE 115-b may identify a failure to successfully receive or decode the downlink message in accordance with the first target BLER if the downlink message is associated with the first set of HARQ process IDs, or in accordance with the second target BLER if the downlink message is associated with the second set of HARQ process IDs.

At 330, the UE 115-b may store, in one or more memories of the UE 115-b, an LLR associated with the downlink message based on a failure to receive or decode the downlink message (e.g., as identified at 320). In some examples, the UE 115-b may store the LLR in accordance with the first log-likelihood compression ratio if the downlink message is associated with the first set of HARQ process IDs, or in accordance with the second log-likelihood compression ratio if the downlink message is associated with the second set of HARQ process IDs.

At 330, the UE 115-b may transmit a feedback message in response to the downlink message (e.g., received at 315). The feedback message may be based on whether or not the downlink message was successfully received/decoded at 320. For example, in cases where the downlink message was not successfully received and/or decoded at step 320 (e.g., step 320=NO), then the feedback message may include a NACK. Comparatively, in cases where the downlink message was successfully received and decoded at step 320 (e.g., step 320=YES), then the feedback message may include an ACK.

The UE 115-b may transmit the feedback message in accordance with one of the set of HARQ-enabled process parameters or the set of HARQ-restricted process parameters based on the HARQ process ID associated with the downlink message. In some cases, the downlink message may be associated with the first set of HARQ process IDs. Even so, in some cases, the UE 115-b may transmit, via the feedback message, an indication that the downlink message was processed in accordance with the set of HARQ-restricted process parameters based on one or more capabilities of the UE 115-b being exceeded.

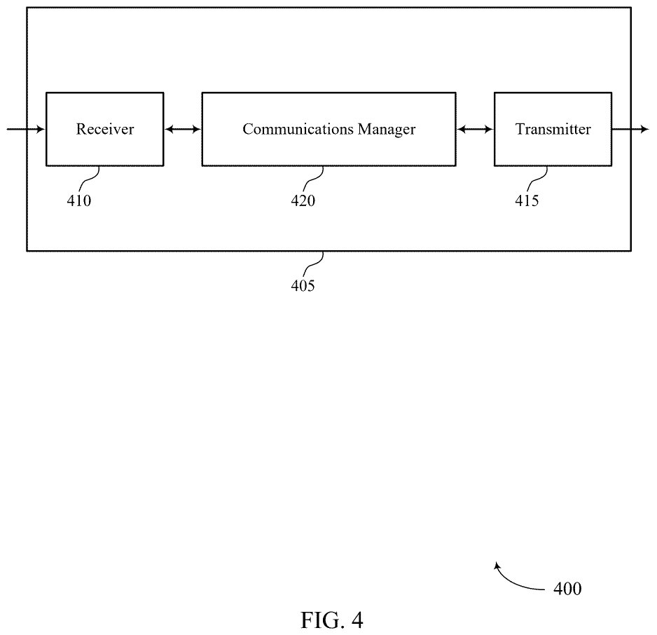

FIG. 4 shows a block diagram 400 of a device 405 that supports feedback process IDs with restricted feedback process functionalities in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to feedback process IDs with restricted feedback process functionalities). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to feedback process IDs with restricted feedback process functionalities). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of feedback process IDs with restricted feedback process functionalities as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, from a network entity, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters. The communications manager 420 is capable of, configured to, or operable to support a means for receiving, from the network entity, a downlink message associated with a HARQ process ID from one of the first set of HARQ process IDs or the second set of HARQ process IDs. The communications manager 420 is capable of, configured to, or operable to support a means for transmitting a feedback message in response to the downlink message and in accordance with one of the set of HARQ-enabled process parameters or the set of HARQ-restricted process parameters based on the HARQ process ID associated with the downlink message.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for feedback process IDs with restricted feedback process functionalities, which may result in reduced processing, improved feedback efficiency, improved signal decoding accuracy, and more efficient utilization of communication resources, among other advantages.

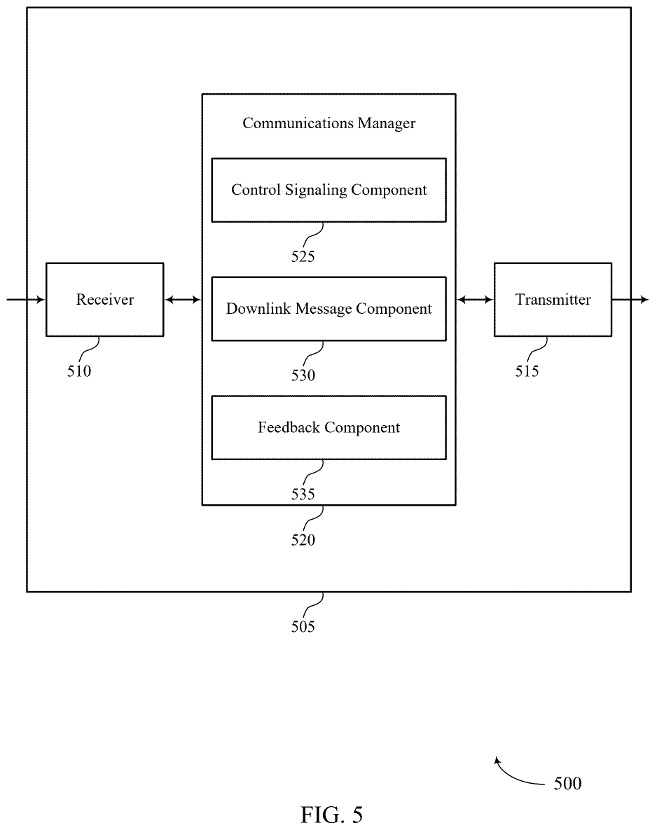

FIG. 5 shows a block diagram 500 of a device 505 that supports feedback process IDs with restricted feedback process functionalities in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to feedback process IDs with restricted feedback process functionalities). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to feedback process IDs with restricted feedback process functionalities). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of feedback process IDs with restricted feedback process functionalities as described herein. For example, the communications manager 520 may include a control signaling component 525, a downlink message component 530, a feedback component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The control signaling component 525 is capable of, configured to, or operable to support a means for receiving, from a network entity, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters. The downlink message component 530 is capable of, configured to, or operable to support a means for receiving, from the network entity, a downlink message associated with a HARQ process ID from one of the first set of HARQ process IDs or the second set of HARQ process IDs. The feedback component 535 is capable of, configured to, or operable to support a means for transmitting a feedback message in response to the downlink message and in accordance with one of the set of HARQ-enabled process parameters or the set of HARQ-restricted process parameters based on the HARQ process ID associated with the downlink message.

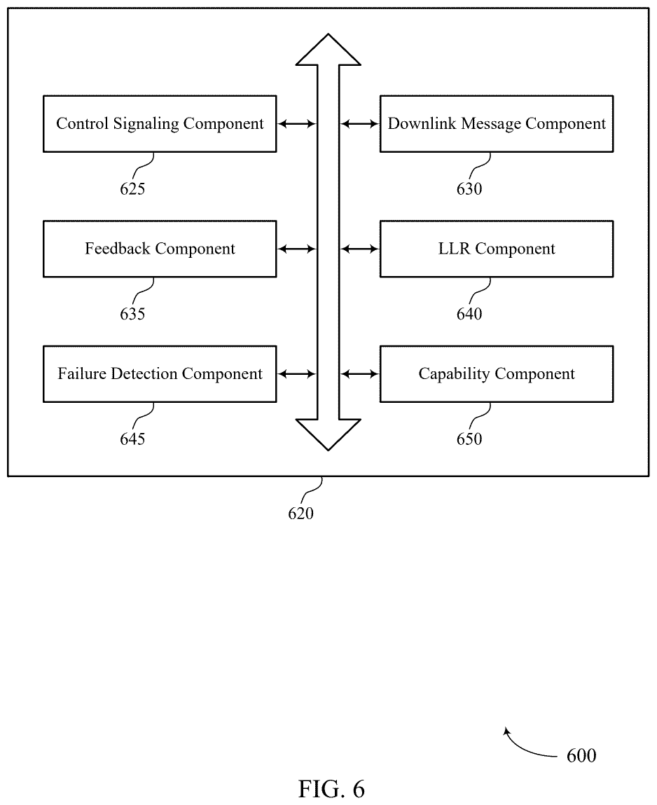

FIG. 6 shows a block diagram 600 of a communications manager 620 that supports feedback process IDs with restricted feedback process functionalities in accordance with one or more aspects of the present disclosure. The communications manager 620 may be an example of aspects of a communications manager 420, a communications manager 520, or both, as described herein. The communications manager 620, or various components thereof, may be an example of means for performing various aspects of feedback process IDs with restricted feedback process functionalities as described herein. For example, the communications manager 620 may include a control signaling component 625, a downlink message component 630, a feedback component 635, an LLR component 640, a failure detection component 645, a capability component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The control signaling component 625 is capable of, configured to, or operable to support a means for receiving, from a network entity, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters. The downlink message component 630 is capable of, configured to, or operable to support a means for receiving, from the network entity, a downlink message associated with a HARQ process ID from one of the first set of HARQ process IDs or the second set of HARQ process IDs. The feedback component 635 is capable of, configured to, or operable to support a means for transmitting a feedback message in response to the downlink message and in accordance with one of the set of HARQ-enabled process parameters or the set of HARQ-restricted process parameters based on the HARQ process ID associated with the downlink message.

In some examples, the set of HARQ-enabled process parameters, the set of HARQ-restricted process parameters, or both, include an LLR compression ratio, a target BLER, a maximum TBS, a downlink message priority, or any combination thereof.

In some examples, the set of HARQ-enabled process parameters include a first log-likelihood compression ratio. In some examples, the set of HARQ-restricted process parameters include a second log-likelihood compression ratio that is associated with a higher rate of compression as compared to the first log-likelihood compression ratio.

In some examples, the LLR component 640 is capable of, configured to, or operable to support a means for storing in memory an LLR associated with the downlink message based on a failure to receive or decode the downlink message, where the LLR is stored in accordance with the first log-likelihood compression ratio based on the downlink message being associated with the first set of HARQ process IDs, or in accordance with the second log-likelihood compression ratio based on the downlink message being associated with the second set of HARQ process IDs.

In some examples, the set of HARQ-enabled process parameters include a first maximum TBS. In some examples, the set of HARQ-restricted process parameters include a second maximum TBS.

In some examples, the downlink message is associated with a TBS. In some examples, the TBS is based on the first maximum TBS based on the downlink message being associated with the first set of HARQ process IDs. In some examples, the TBS is based on the second maximum TBS based on the downlink message being associated with the second set of HARQ process IDs.

In some examples, the set of HARQ-enabled process parameters include a first target BLER. In some examples, the set of HARQ-restricted process parameters include a second target BLER that is less than the first target BLER.

In some examples, the failure detection component 645 is capable of, configured to, or operable to support a means for identifying a failure to successfully receive or decode the downlink message, where the failure is identified in accordance with the first target BLER based on the downlink message being associated with the first set of HARQ process IDs, or in accordance with the second target BLER based on the downlink message being associated with the second set of HARQ process IDs. In some examples, the LLR component 640 is capable of, configured to, or operable to support a means for storing in memory an LLR associated with the downlink message based on the failure.

In some examples, the first set of HARQ process IDs and the second set of HARQ process IDs are based at least in a part on one or more capabilities of the UE.

In some examples, the capability component 650 is capable of, configured to, or operable to support a means for transmitting, to the network entity, capability signaling indicating the one or more capabilities of the UE, where the control signaling is received based on the capability signaling.

In some examples, the one or more capabilities of the UE include a maximum quantity of total HARQ process IDs supported at the UE per component carrier, a maximum quantity of HARQ-enabled process IDs supported at the UE per component carrier, a maximum quantity of HARQ-restricted process IDs supported at the UE per component carrier, a processing or memory capability of the UE, or any combination thereof.

In some examples, the control signaling includes radio resource control signaling, medium access control-control element signaling, downlink control information signaling, or any combination thereof.

In some examples, the downlink message is associated with the first set of HARQ process IDs, and the feedback component 635 is capable of, configured to, or operable to support a means for transmitting, via the feedback message, an indication that the downlink message was processed in accordance with the set of HARQ-restricted process parameters based on one or more capabilities of the UE being exceeded.

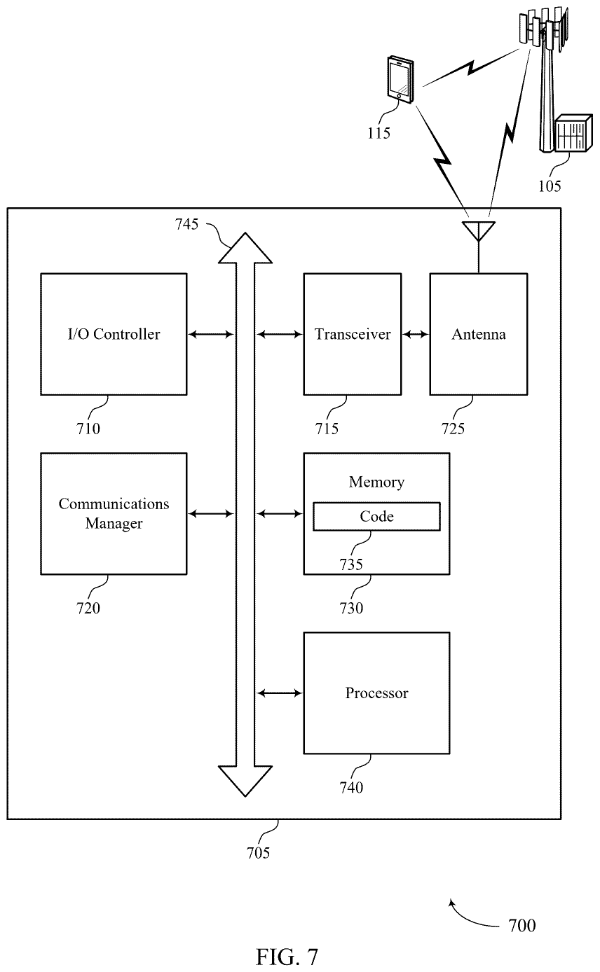

FIG. 7 shows a diagram of a system 700 including a device 705 that supports feedback process IDs with restricted feedback process functionalities in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting feedback process IDs with restricted feedback process functionalities). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, from a network entity, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters. The communications manager 720 is capable of, configured to, or operable to support a means for receiving, from the network entity, a downlink message associated with a HARQ process ID from one of the first set of HARQ process IDs or the second set of HARQ process IDs. The communications manager 720 is capable of, configured to, or operable to support a means for transmitting a feedback message in response to the downlink message and in accordance with one of the set of HARQ-enabled process parameters or the set of HARQ-restricted process parameters based on the HARQ process ID associated with the downlink message.

By including or configuring the communications manager 720 in accordance with examples as described herein, the device 705 may support techniques for feedback process IDs with restricted feedback process functionalities, which may result in improved communication reliability, reduced latency, improved user experience related to reduced processing, improved feedback efficiency, improved signal decoding accuracy, improved coordination between devices, improved utilization of processing capability, and more efficient utilization of communication resources, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of feedback process IDs with restricted feedback process functionalities as described herein, or the at least one processor 740 and the at least one memory 730 may be otherwise configured to, individually or collectively, perform or support such operations.

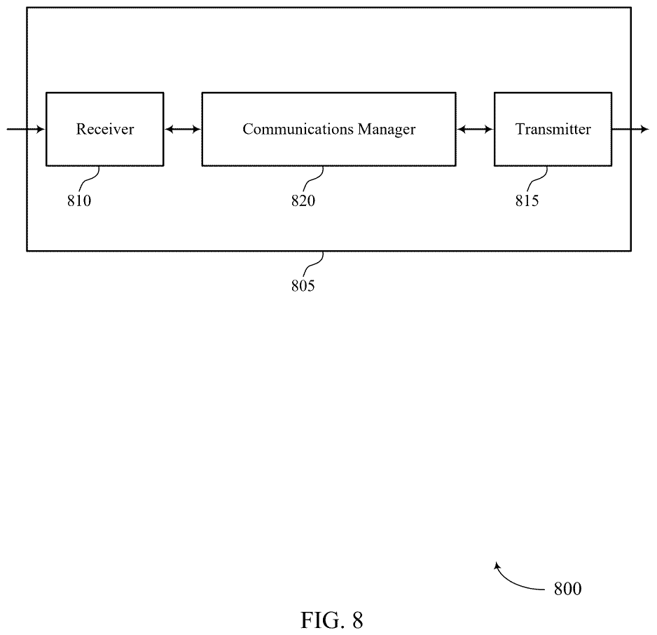

FIG. 8 shows a block diagram 800 of a device 805 that supports feedback process IDs with restricted feedback process functionalities in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of feedback process IDs with restricted feedback process functionalities as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting, to a UE, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters. The communications manager 820 is capable of, configured to, or operable to support a means for outputting, to the UE, a downlink message associated with a HARQ process ID from one of the first set of HARQ process IDs or the second set of HARQ process IDs. The communications manager 820 is capable of, configured to, or operable to support a means for obtaining a feedback message in response to the downlink message and in accordance with one of the set of HARQ-enabled process parameters or the set of HARQ-restricted process parameters based on the HARQ process ID associated with the downlink message.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for feedback process IDs with restricted feedback process functionalities, which may result in reduced processing, improved feedback efficiency, improved signal decoding accuracy, and more efficient utilization of communication resources, among other advantages.

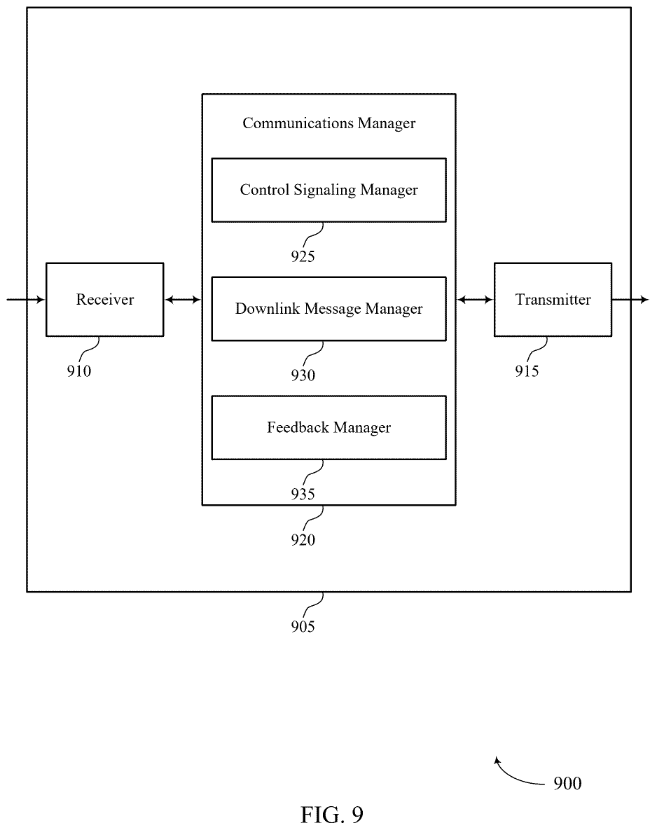

FIG. 9 shows a block diagram 900 of a device 905 that supports feedback process IDs with restricted feedback process functionalities in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of feedback process IDs with restricted feedback process functionalities as described herein. For example, the communications manager 920 may include a control signaling manager 925, a downlink message manager 930, a feedback manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The control signaling manager 925 is capable of, configured to, or operable to support a means for outputting, to a UE, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters. The downlink message manager 930 is capable of, configured to, or operable to support a means for outputting, to the UE, a downlink message associated with a HARQ process ID from one of the first set of HARQ process IDs or the second set of HARQ process IDs. The feedback manager 935 is capable of, configured to, or operable to support a means for obtaining a feedback message in response to the downlink message and in accordance with one of the set of HARQ-enabled process parameters or the set of HARQ-restricted process parameters based on the HARQ process ID associated with the downlink message.

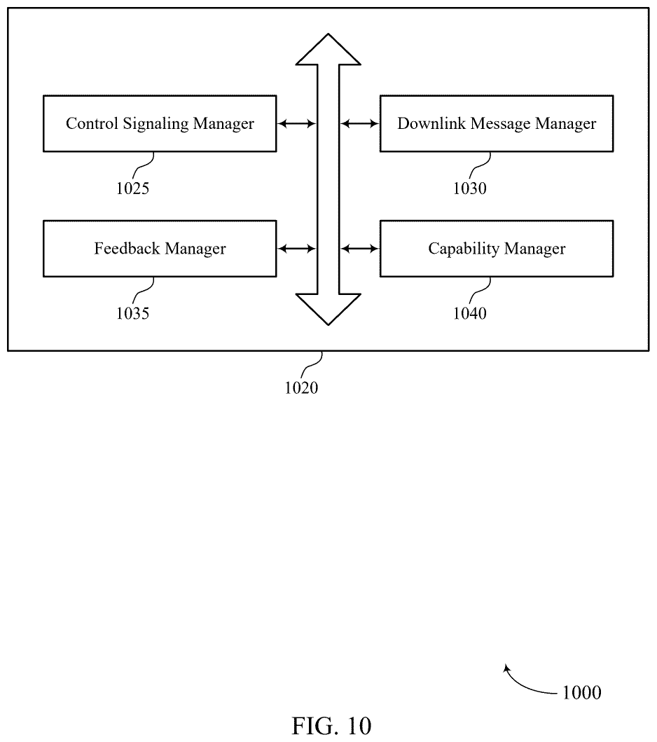

FIG. 10 shows a block diagram 1000 of a communications manager 1020 that supports feedback process IDs with restricted feedback process functionalities in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of feedback process IDs with restricted feedback process functionalities as described herein. For example, the communications manager 1020 may include a control signaling manager 1025, a downlink message manager 1030, a feedback manager 1035, a capability manager 1040, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The control signaling manager 1025 is capable of, configured to, or operable to support a means for outputting, to a UE, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters. The downlink message manager 1030 is capable of, configured to, or operable to support a means for outputting, to the UE, a downlink message associated with a HARQ process ID from one of the first set of HARQ process IDs or the second set of HARQ process IDs. The feedback manager 1035 is capable of, configured to, or operable to support a means for obtaining a feedback message in response to the downlink message and in accordance with one of the set of HARQ-enabled process parameters or the set of HARQ-restricted process parameters based on the HARQ process ID associated with the downlink message.

In some examples, the set of HARQ-enabled process parameters, the set of HARQ-restricted process parameters, or both, include an LLR compression ratio, a target BLER, a maximum TBS, a downlink message priority, or any combination thereof.

In some examples, the set of HARQ-enabled process parameters include a first log-likelihood compression ratio. In some examples, the set of HARQ-restricted process parameters include a second log-likelihood compression ratio that is associated with a higher rate of compression as compared to the first log-likelihood compression ratio.

In some examples, the set of HARQ-enabled process parameters include a first maximum TBS. In some examples, the set of HARQ-restricted process parameters include a second maximum TBS.

In some examples, the downlink message is transmitted associated with a TBS. In some examples, the TBS is based on the first maximum TBS based on the downlink message being associated with the first set of HARQ process IDs. In some examples, the TBS is based on the second maximum TBS based on the downlink message being associated with the second set of HARQ process IDs.

In some examples, the set of HARQ-enabled process parameters include a first target BLER. In some examples, the set of HARQ-restricted process parameters include a second target BLER that is less than the first target BLER.

In some examples, the first set of HARQ process IDs and the second set of HARQ process IDs are based at least in a part on one or more capabilities of the UE.

In some examples, the capability manager 1040 is capable of, configured to, or operable to support a means for obtaining, from the UE, capability signaling indicating the one or more capabilities of the UE, where the control signaling is transmitted based on the capability signaling.

In some examples, the one or more capabilities of the UE include a maximum quantity of total HARQ process IDs supported at the UE per component carrier, a maximum quantity of HARQ-enabled process IDs supported at the UE per component carrier, a maximum quantity of HARQ-restricted process IDs supported at the UE per component carrier, a processing or memory capability of the UE, or any combination thereof.

In some examples, the control signaling includes radio resource control signaling, medium access control-control element signaling, downlink control information signaling, or any combination thereof.

In some examples, the downlink message is associated with the first set of HARQ process IDs, and the feedback manager 1035 is capable of, configured to, or operable to support a means for obtaining, via the feedback message, an indication that the downlink message was processed in accordance with the set of HARQ-restricted process parameters based on one or more capabilities of the UE being exceeded.

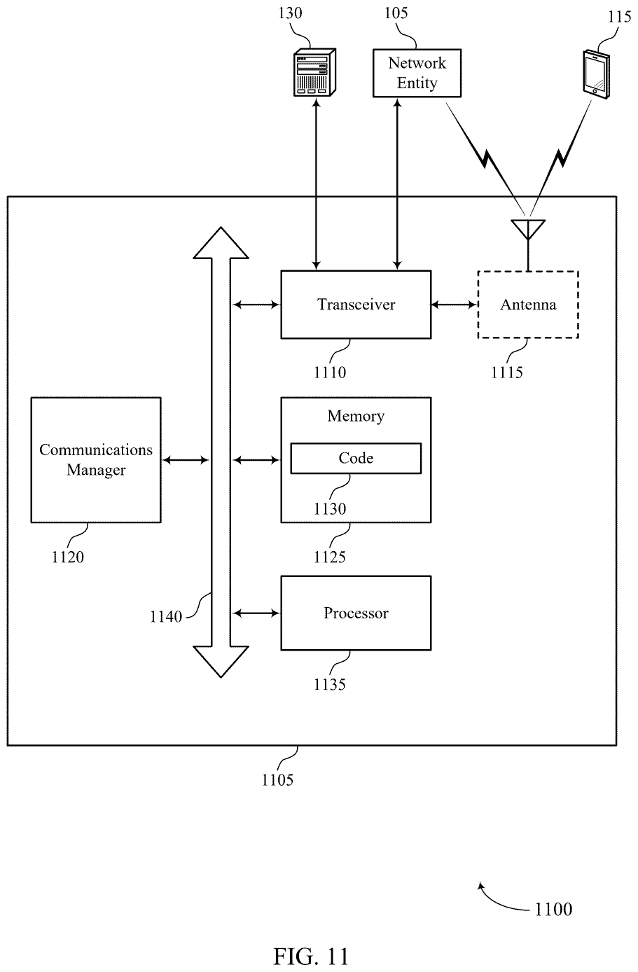

FIG. 11 shows a diagram of a system 1100 including a device 1105 that supports feedback process IDs with restricted feedback process functionalities in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting feedback process IDs with restricted feedback process functionalities). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting, to a UE, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters. The communications manager 1120 is capable of, configured to, or operable to support a means for outputting, to the UE, a downlink message associated with a HARQ process ID from one of the first set of HARQ process IDs or the second set of HARQ process IDs. The communications manager 1120 is capable of, configured to, or operable to support a means for obtaining a feedback message in response to the downlink message and in accordance with one of the set of HARQ-enabled process parameters or the set of HARQ-restricted process parameters based on the HARQ process ID associated with the downlink message.

By including or configuring the communications manager 1120 in accordance with examples as described herein, the device 1105 may support techniques for feedback process IDs with restricted feedback process functionalities, which may result in improved communication reliability, reduced latency, improved user experience related to reduced processing, improved feedback efficiency, improved signal decoding accuracy, improved coordination between devices, improved utilization of processing capability, and more efficient utilization of communication resources, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of feedback process IDs with restricted feedback process functionalities as described herein, or the at least one processor 1135 and the at least one memory 1125 may be otherwise configured to, individually or collectively, perform or support such operations.

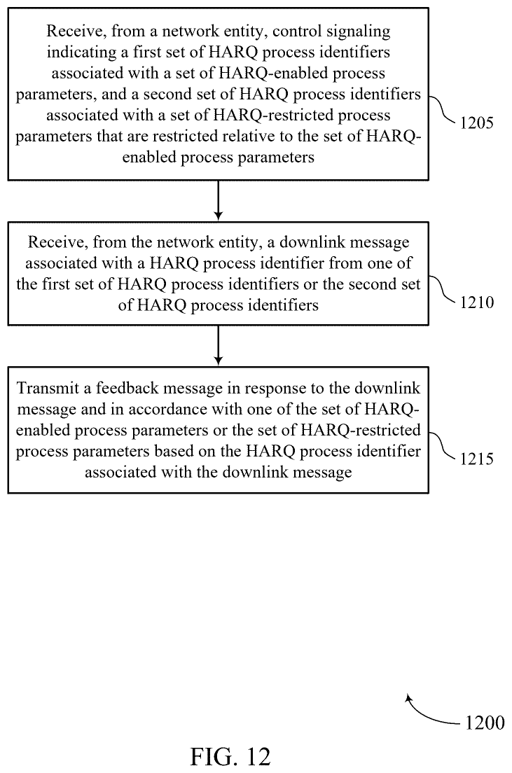

FIG. 12 shows a flowchart illustrating a method 1200 that supports feedback process IDs with restricted feedback process functionalities in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters. The operations of 1205 may be performed in accordance with examples as disclosed herein. In some examples, aspects of the operations of 1205 may be performed by a control signaling component 625 as described with reference to FIG. 6.

At 1210, the method may include receiving, from the network entity, a downlink message associated with a HARQ process ID from one of the first set of HARQ process IDs or the second set of HARQ process IDs. The operations of 1210 may be performed in accordance with examples as disclosed herein. In some examples, aspects of the operations of 1210 may be performed by a downlink message component 630 as described with reference to FIG. 6.

At 1215, the method may include transmitting a feedback message in response to the downlink message and in accordance with one of the set of HARQ-enabled process parameters or the set of HARQ-restricted process parameters based on the HARQ process ID associated with the downlink message. The operations of 1215 may be performed in accordance with examples as disclosed herein. In some examples, aspects of the operations of 1215 may be performed by a feedback component 635 as described with reference to FIG. 6.

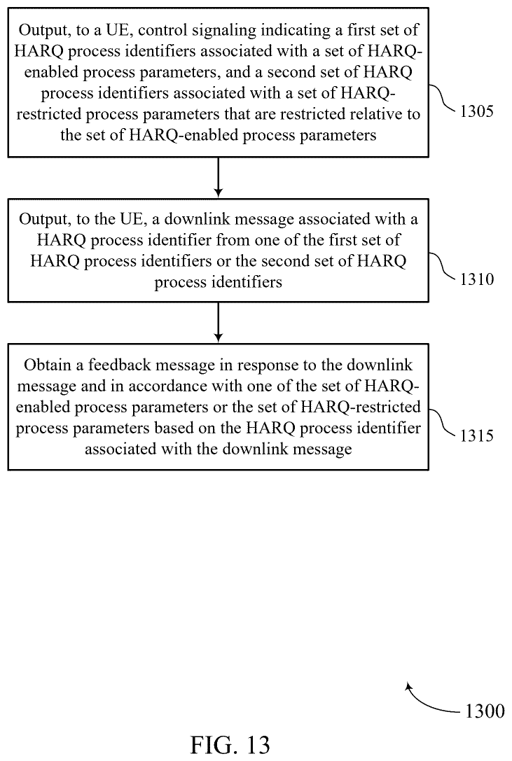

FIG. 13 shows a flowchart illustrating a method 1300 that supports feedback process IDs with restricted feedback process functionalities in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include outputting, to a UE, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters. The operations of 1305 may be performed in accordance with examples as disclosed herein. In some examples, aspects of the operations of 1305 may be performed by a control signaling manager 1025 as described with reference to FIG. 10.

At 1310, the method may include outputting, to the UE, a downlink message associated with a HARQ process ID from one of the first set of HARQ process IDs or the second set of HARQ process IDs. The operations of 1310 may be performed in accordance with examples as disclosed herein. In some examples, aspects of the operations of 1310 may be performed by a downlink message manager 1030 as described with reference to FIG. 10.

At 1315, the method may include obtaining a feedback message in response to the downlink message and in accordance with one of the set of HARQ-enabled process parameters or the set of HARQ-restricted process parameters based on the HARQ process ID associated with the downlink message. The operations of 1315 may be performed in accordance with examples as disclosed herein. In some examples, aspects of the operations of 1315 may be performed by a feedback manager 1035 as described with reference to FIG. 10.

The following provides an overview of aspects of the present disclosure:

Aspect 1: A method for wireless communications at a UE, comprising: receiving, from a network entity, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters; receiving, from the network entity, a downlink message associated with a HARQ process ID from one of the first set of HARQ process IDs or the second set of HARQ process IDs; and transmitting a feedback message in response to the downlink message and in accordance with one of the set of HARQ-enabled process parameters or the set of HARQ-restricted process parameters based at least in part on the HARQ process ID associated with the downlink message.

Aspect 2: The method of aspect 1, wherein the set of HARQ-enabled process parameters, the set of HARQ-restricted process parameters, or both, comprise an LLR compression ratio, a target BLER, a maximum TBS, a downlink message priority, or any combination thereof.

Aspect 3: The method of any of aspects 1 through 2, wherein the set of HARQ-enabled process parameters comprise a first log-likelihood compression ratio, and the set of HARQ-restricted process parameters comprise a second log-likelihood compression ratio that is associated with a higher rate of compression as compared to the first log-likelihood compression ratio.

Aspect 4: The method of aspect 3, further comprising: storing in memory an LLR associated with the downlink message based at least in part on a failure to receive or decode the downlink message, wherein the LLR is stored in accordance with the first log-likelihood compression ratio based at least in part on the downlink message being associated with the first set of HARQ process IDs, or in accordance with the second log-likelihood compression ratio based at least in part on the downlink message being associated with the second set of HARQ process IDs.

Aspect 5: The method of any of aspects 1 through 4, wherein the set of HARQ-enabled process parameters comprise a first maximum TBS, and the set of HARQ-restricted process parameters comprise a second maximum TBS.

Aspect 6: The method of aspect 5, wherein the downlink message is associated with a TBS, the TBS is based at least in part on the first maximum TBS based at least in part on the downlink message being associated with the first set of HARQ process IDs, or the TBS is based at least in part on the second maximum TBS based at least in part on the downlink message being associated with the second set of HARQ process IDs.

Aspect 7: The method of any of aspects 1 through 6, wherein the set of HARQ-enabled process parameters comprise a first target BLER, and the set of HARQ-restricted process parameters comprise a second target BLER that is less than the first target BLER.

Aspect 8: The method of aspect 7, further comprising: identifying a failure to successfully receive or decode the downlink message, wherein the failure is identified in accordance with the first target BLER based at least in part on the downlink message being associated with the first set of HARQ process IDs, or in accordance with the second target BLER based at least in part on the downlink message being associated with the second set of HARQ process IDs; and storing in memory an LLR associated with the downlink message based at least in part on the failure.

Aspect 9: The method of any of aspects 1 through 8, wherein the first set of HARQ process IDs and the second set of HARQ process IDs are based at least in a part on one or more capabilities of the UE.

Aspect 10: The method of aspect 9, further comprising: transmitting, to the network entity, capability signaling indicating the one or more capabilities of the UE, wherein the control signaling is received based at least in part on the capability signaling.

Aspect 11: The method of any of aspects 9 through 10, wherein the one or more capabilities of the UE comprise a maximum quantity of total HARQ process IDs supported at the UE per component carrier, a maximum quantity of HARQ-enabled process IDs supported at the UE per component carrier, a maximum quantity of HARQ-restricted process IDs supported at the UE per component carrier, a processing or memory capability of the UE, or any combination thereof.

Aspect 12: The method of any of aspects 1 through 11, wherein the control signaling comprises radio resource control signaling, medium access control-control element signaling, downlink control information signaling, or any combination thereof.

Aspect 13: The method of any of aspects 1 through 12, wherein the downlink message is associated with the first set of HARQ process IDs, the method further comprising: transmitting, via the feedback message, an indication that the downlink message was processed in accordance with the set of HARQ-restricted process parameters based at least in part on one or more capabilities of the UE being exceeded.

Aspect 14: A method for wireless communications at a network entity, comprising: outputting, to a UE, control signaling indicating a first set of HARQ process IDs associated with a set of HARQ-enabled process parameters, and a second set of HARQ process IDs associated with a set of HARQ-restricted process parameters that are restricted relative to the set of HARQ-enabled process parameters; outputting, to the UE, a downlink message associated with a HARQ process ID from one of the first set of HARQ process IDs or the second set of HARQ process IDs; and obtaining a feedback message in response to the downlink message and in accordance with one of the set of HARQ-enabled process parameters or the set of HARQ-restricted process parameters based at least in part on the HARQ process ID associated with the downlink message.

Aspect 15: The method of aspect 14, wherein the set of HARQ-enabled process parameters, the set of HARQ-restricted process parameters, or both, comprise an LLR compression ratio, a target BLER, a maximum TBS, a downlink message priority, or any combination thereof.

Aspect 16: The method of any of aspects 14 through 15, wherein the set of HARQ-enabled process parameters comprise a first log-likelihood compression ratio, and the set of HARQ-restricted process parameters comprise a second log-likelihood compression ratio that is associated with a higher rate of compression as compared to the first log-likelihood compression ratio.

Aspect 17: The method of any of aspects 14 through 16, wherein the set of HARQ-enabled process parameters comprise a first maximum TBS, and the set of HARQ-restricted process parameters comprise a second maximum TBS.

Aspect 18: The method of aspect 17, wherein the downlink message is transmitted associated with a TBS, the TBS is based at least in part on the first maximum TBS based at least in part on the downlink message being associated with the first set of HARQ process IDs, or the TBS is based at least in part on the second maximum TBS based at least in part on the downlink message being associated with the second set of HARQ process IDs.

Aspect 19: The method of any of aspects 14 through 18, wherein the set of HARQ-enabled process parameters comprise a first target BLER, and the set of HARQ-restricted process parameters comprise a second target BLER that is less than the first target BLER.

Aspect 20: The method of any of aspects 14 through 19, wherein the first set of HARQ process IDs and the second set of HARQ process IDs are based at least in a part on one or more capabilities of the UE.

Aspect 21: The method of aspect 20, further comprising: obtaining, from the UE, capability signaling indicating the one or more capabilities of the UE, wherein the control signaling is transmitted based at least in part on the capability signaling.

Aspect 22: The method of aspect 21, wherein the one or more capabilities of the UE comprise a maximum quantity of total HARQ process IDs supported at the UE per component carrier, a maximum quantity of HARQ-enabled process IDs supported at the UE per component carrier, a maximum quantity of HARQ-restricted process IDs supported at the UE per component carrier, a processing or memory capability of the UE, or any combination thereof.

Aspect 23: The method of any of aspects 14 through 22, wherein the control signaling comprises radio resource control signaling, medium access control-control element signaling, downlink control information signaling, or any combination thereof.

Aspect 24: The method of any of aspects 14 through 23, wherein the downlink message is associated with the first set of HARQ process IDs, the method further comprising: obtaining, via the feedback message, an indication that the downlink message was processed in accordance with the set of HARQ-restricted process parameters based at least in part on one or more capabilities of the UE being exceeded.

Aspect 25: A UE for wireless communications, comprising one or more memories storing processor-executable code, and one or more processors coupled with the one or more memories and individually or collectively operable to execute the code to cause the UE to perform a method of any of aspects 1 through 13.

Aspect 26: A UE for wireless communications, comprising at least one means for performing a method of any of aspects 1 through 13.

Aspect 27: A non-transitory computer-readable medium storing code for wireless communications, the code comprising instructions executable by one or more processors to perform a method of any of aspects 1 through 13.

Aspect 28: A network entity for wireless communications, comprising one or more memories storing processor-executable code, and one or more processors coupled with the one or more memories and individually or collectively operable to execute the code to cause the network entity to perform a method of any of aspects 14 through 24.

Aspect 29: A network entity for wireless communications, comprising at least one means for performing a method of any of aspects 14 through 24.

Aspect 30: A non-transitory computer-readable medium storing code for wireless communications, the code comprising instructions executable by one or more processors to perform a method of any of aspects 14 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, control signaling indicating a first set of hybrid automatic repeat request (HARQ) process identifiers associated with a set of HARQ-enabled process parameters, and a second set of HARQ process identifiers associated with a set of HARQ-restricted process parameters that are restricted relative to the set of HARQ-enabled process parameters;
receive, from the network entity, a downlink message associated with a HARQ process identifier from one of the first set of HARQ process identifiers or the second set of HARQ process identifiers; and
transmit a feedback message in response to the downlink message and in accordance with one of the set of HARQ-enabled process parameters or the set of HARQ-restricted process parameters based at least in part on the HARQ process identifier associated with the downlink message.

2. The UE of claim 1, wherein the set of HARQ-enabled process parameters, the set of HARQ-restricted process parameters, or both, comprise a log-likelihood ratio compression ratio, a target block error rate, a maximum transport block size, a downlink message priority, or any combination thereof.

3. The UE of claim 1, wherein:
the set of HARQ-enabled process parameters comprise a first log-likelihood compression ratio, and
the set of HARQ-restricted process parameters comprise a second log-likelihood compression ratio that is associated with a higher rate of compression as compared to the first log-likelihood compression ratio.

4. The UE of claim 3, wherein the one or more processors are individually or collectively further operable to execute the code to cause the UE to:
store in memory a log-likelihood ratio associated with the downlink message based at least in part on a failure to receive or decode the downlink message, wherein the log-likelihood ratio is stored in accordance with the first log-likelihood compression ratio based at least in part on the downlink message being associated with the first set of HARQ process identifiers, or in accordance with the second log-likelihood compression ratio based at least in part on the downlink message being associated with the second set of HARQ process identifiers.

5. The UE of claim 1, wherein the set of HARQ-enabled process parameters comprise a first maximum transport block size, and wherein the set of HARQ-restricted process parameters comprise a second maximum transport block size.

6. The UE of claim 5, wherein the downlink message is associated with a transport block size,
the transport block size is based at least in part on the first maximum transport block size based at least in part on the downlink message being associated with the first set of HARQ process identifiers, or
the transport block size is based at least in part on the second maximum transport block size based at least in part on the downlink message being associated with the second set of HARQ process identifiers.

7. The UE of claim 1, wherein the set of HARQ-enabled process parameters comprise a first target block error rate, and wherein the set of HARQ-restricted process parameters comprise a second target block error rate that is less than the first target block error rate.

8. The UE of claim 7, wherein the one or more processors are individually or collectively further operable to execute the code to cause the UE to:
identify a failure to successfully receive or decode the downlink message, wherein the failure is identified in accordance with the first target block error rate based at least in part on the downlink message being associated with the first set of HARQ process identifiers, or in accordance with the second target block error rate based at least in part on the downlink message being associated with the second set of HARQ process identifiers; and
store in memory a log-likelihood ratio associated with the downlink message based at least in part on the failure.

9. The UE of claim 1, wherein the first set of HARQ process identifiers and the second set of HARQ process identifiers are based at least in a part on one or more capabilities of the UE.

10. The UE of claim 9, wherein the one or more processors are individually or collectively further operable to execute the code to cause the UE to:
transmit, to the network entity, capability signaling indicating the one or more capabilities of the UE, wherein the control signaling is received based at least in part on the capability signaling.

11. The UE of claim 9, wherein the one or more capabilities of the UE comprise a maximum quantity of total HARQ process identifiers supported at the UE per component carrier, a maximum quantity of HARQ-enabled process identifiers supported at the UE per component carrier, a maximum quantity of HARQ-restricted process identifiers supported at the UE per component carrier, a processing or memory capability of the UE, or any combination thereof.

12. The UE of claim 1, wherein the control signaling comprises radio resource control signaling, medium access control-control element signaling, downlink control information signaling, or any combination thereof.

13. The UE of claim 1, wherein the downlink message is associated with the first set of HARQ process identifiers, and the one or more processors are individually or collectively further operable to execute the code to cause the UE to:
transmit, via the feedback message, an indication that the downlink message was processed in accordance with the set of HARQ-restricted process parameters based at least in part on one or more capabilities of the UE being exceeded.

14. A network entity, comprising:
one or more memories storing processor-executable code; and
one or more processors coupled with the one or more memories and individually or collectively operable to execute the code to cause the network entity to:
output, to a user equipment (UE), control signaling indicating a first set of hybrid automatic repeat request (HARQ) process identifiers associated with a set of HARQ-enabled process parameters, and a second set of HARQ process identifiers associated with a set of HARQ-restricted process parameters that are restricted relative to the set of HARQ-enabled process parameters;
output, to the UE, a downlink message associated with a HARQ process identifier from one of the first set of HARQ process identifiers or the second set of HARQ process identifiers; and
obtain a feedback message in response to the downlink message and in accordance with one of the set of HARQ-enabled process parameters or the set of HARQ-restricted process parameters based at least in part on the HARQ process identifier associated with the downlink message.

15. The network entity of claim 14, wherein the set of HARQ-enabled process parameters, the set of HARQ-restricted process parameters, or both, comprise a log-likelihood ratio compression ratio, a target block error rate, a maximum transport block size, a downlink message priority, or any combination thereof.

16. The network entity of claim 14, wherein the set of HARQ-enabled process parameters comprise a first log-likelihood compression ratio, and wherein set of HARQ-restricted process parameters comprise a second log-likelihood compression ratio that is associated with a higher rate of compression as compared to the first log-likelihood compression ratio.

17. The network entity of claim 14, wherein the set of HARQ-enabled process parameters comprise a first maximum transport block size, and wherein the set of HARQ-restricted process parameters comprise a second maximum transport block size.

18. The network entity of claim 17, wherein the downlink message is transmitted associated with a transport block size,
wherein the transport block size is based at least in part on the first maximum transport block size based at least in part on the downlink message being associated with the first set of HARQ process identifiers, or
wherein the transport block size is based at least in part on the second maximum transport block size based at least in part on the downlink message being associated with the second set of HARQ process identifiers.

19. The network entity of claim 14, wherein the set of HARQ-enabled process parameters comprise a first target block error rate, and wherein the set of HARQ-restricted process parameters comprise a second target block error rate that is less than the first target block error rate.

20. A method for wireless communications at a user equipment (UE), comprising:
receiving, from a network entity, control signaling indicating a first set of hybrid automatic repeat request (HARQ) process identifiers associated with a set of HARQ-enabled process parameters, and a second set of HARQ process identifiers associated with a set of HARQ-restricted process parameters that are restricted relative to the set of HARQ-enabled process parameters;
receiving, from the network entity, a downlink message associated with a HARQ process identifier from one of the first set of HARQ process identifiers or the second set of HARQ process identifiers; and
transmitting a feedback message in response to the downlink message and in accordance with one of the set of HARQ-enabled process parameters or the set of HARQ-restricted process parameters based at least in part on the HARQ process identifier associated with the downlink message.
